(19) United States
(12) Patent Application Publication
(10) Pub. No.: US 2006/0289661 A1
(43) Pub. Date: Dec. 28, 2006

(54) Bi-directional readable two-dimensional bar code system and its reading method

(76) Inventor: Longxiang Bian, Shanghai (CN)

Correspondence Address: CONNOLLY BOVE LODGE & HUTZ, LLP, P O BOX 2207, WILMINGTON, DE, 19899, US

(21) Appl. No.: 10/558,880

(22) PCT Filed: May 31, 2004
(86) PCT No.: PCT/CN04/00568

§ 371 Date: Jan. 6, 2006

(30) Foreign Application Priority Data
May 30, 2003 (CN) 03128955.X

(51) Int. Cl. G06K 19/06; G06K 7/10

(52) U.S. Cl. 235/494; 235/462.1

(57) ABSTRACT

The present invention discloses a two-dimensional bar code system recognizable in bidirection having high information storage density and reliable locating capability and a recognition method thereof. In this two-dimensional bar code system, an encoding region consists of nodes arranged in a form of matrix, wherein an encoding information sequence is disposed sequentially on said nodes of said matrix in one recognition direction and in a reversible order, and comprises directional symbols, wherein said directional symbols are arranged at specific locations having bilateral symmetry in said encoding information sequence, and said direction in which said encoding information sequence is disposed on said node of said matrix is identified by a combination of said specific locations and values of said directional symbols.

### FIELD OF THE INVENTION

The present invention relates to bar code system, in particular, to a two-dimensional bar code system recognizable in bidirection and a recognition method thereof.

### BACKGROUND ART

Bar code is a special optical symbol system recognizable by an optical scanning apparatus and has been used widely in the various fields. According to the number of its spatial dimensions, bar code system can be classified into one-dimensional bar code, stack bar code, and two-dimensional bar code.

An one-dimensional bar code system is composed of a series of black bars (bars) and white bars (spaces) arranged in parallel, and in most of one-dimensional bar code system, information is encoded with the widths of these black bars and white bars. When recognizing this one-dimensional bar code, a recognition device scans the bar code sequentially, and a sequence relating to width data of a group of black bars and white bars can be thus obtained by measuring the scanned tracks. One-dimensional bar code system is designed to be decoded with the sequence of the width data only in one direction at any time, and decoding in opposite direction is impossible. Therefore, one-dimensional bar code system, e.g., code 25 bar code and UPC bar code, and the like, has uniqueness in terms of direction, even if an one-dimensional bar code is polluted or damaged. In another one-dimensional bar codes (for example, bar code-93, bar code-128, and the like), a start character and a stop character are set to further ensure this uniqueness during recognition. A plurality of one-dimensional bar codes are stacked to form a stack bar code, which has the same recognizable capability as that of the above one-dimensional bar code systems.

Two-dimensional bar code is a system with structure and principle completely different from one-dimensional bar code and stack bar code, wherein encoding information sequence is disposed on encoding information cells within an encoding region. A form of matrix is usually used for these encoding information cells, it starts from a start point in the matrix when encoding, and the encoding information is disposed in the cells according to a distributional rule. Similarly, it also starts from the same start point in the said matrix when decoding, and available information are extracted form the encoding information cells according to the same rules and sent to a decoding system. Obviously, in order to restore information correctly, the start points for encoding and decoding shall coincide with each other and the encoding information sequence shall be disposed and read according to the same distributional rule. The various functional patterns are used for locating the start points so as to allow a image processing system to determine the start point. For example, in QR Code, special position-detecting patterns are disposed on three of four corners as shown in FIG. 1a; as shown in FIG. 1b, in Maxi Code, there is a group of concentric circles at the center, and six groups of the locating information units (three locating information units for each group) near said group of the concentric circles are used to locate their respective start points.

From the above, the following deficiencies exist when locating in the above two-dimensional bar code system. Firstly, the functional patterns for locating the start point occupy significant area in the bar code region, resulting in a reduction of the area of the encoding region, and reducing information storage density. Secondly and more seriously, the functional patterns lack protection, once damaged, failure in decoding will occur.

### SUMMARY IN INVENTION

An object of the present invention is to provide a two-dimensional bar code system having high information storage density and reliable locating capability.

The above and other objects of the invention are implemented by the following approaches:

a two-dimensional bar code system recognizable in bidirection, including an encoding region consisting of nodes arranged in a form of matrix, wherein an encoding information sequence is disposed sequentially on said nodes of said matrix in one direction and in a reversible order, and comprises directional symbols, wherein said directional symbols are arranged at specific locations having bilateral symmetry in said encoding information sequence, and said direction in which said encoding information sequence is disposed on said node of said matrix is identified by a combination of said specific locations and values of said directional symbols.

Preferably, in the above system, said directional symbols comprise data symbols and error-correcting symbols.

Preferably, in the above system, said directional symbols consist of symbols S₁₁, S₁₀, . . . , S₁, S₀, STA, R₁, R₂, R₃, R₄, STO, S′₀, S′₁, . . . , S′₁₀, S′₁₁, which comply with a relationship as follow: a symbol sequence {STO, R₄, R₃, R₂, R₁, STA, S₀, S₁, . . . , S₁₀, S₁₁} acts as one BCH (18, 6) error-correcting code sequence, a symbol sequence {STA, R₁, R₂, R₃, R₄, STO, S′₀, S′₁, . . . , S′₁₀, S′₁₁} acts as another BCH (18, 6) error-correcting code sequence, symbols STA, STO and R₁≈R₄ are said data symbols, symbols STA, STO function as locating control characters indicating said direction, R₁≈R₄ functions as normal information characters, S₀≈S₁₁ and S′₀≈S′₁₁ are said error-correcting symbols belonging to said error-correcting code sequences.

Preferably, in the above system, said directional symbols are arranged at said specific locations having bilateral symmetry in such a way that: said directional symbols R₂, R₁, STA, S₀, S₁, . . . , S₁₀, S₁₁ correspond to locations within left half part of said encoding information sequence according to a distributional rule, and said directional symbols R₃, R₄, STO, S′₀, S′₁, . . . , S′₁₀, S′₁₁ correspond to locations within right half part of said encoding information sequence according to said distributional rule.

Preferably, in the above system, said distributional rule complies with an analog random discrete distribution.

Another object of the invention is to provide a method for recognizing the above two-dimensional bar code system. The above and other objects of the invention are implemented by the following approaches:

a method for recognizing a two-dimensional bar code system, comprising the steps of:

(1) reading encoding information at said nodes within said matrix in one recognition direction and in said reversible order to obtain said encoding information sequence;

(2) extracting said directional symbols from said specific locations in obtained encoding information sequence; and

(3) determining said direction in which said encoding information sequence is disposed on said node of said matrix based on said combination of said specific locations and values of said directional symbols.

Preferably, in the above method, said directional symbols comprise data symbols and error-correcting symbols.

Form the above, because a small amount of locating symbols is used in the two-dimensional bar code system according to the invention to identify the decoding direction, therefore, comparing with the prior art in which the functional pattern is used, the available area of the encoding region increases, and the information storage density increases significantly. Furthermore, because the locating information is arranged on the nodes in encoding process, the probability of losing locating information can be reduced by means of suitable selection of distributional rule, and the reliability can be improved. Furthermore, in the present invention, the reliability increases significantly by applying an error-correcting protection function to directional information.

### BRIEF DESCRIPTION ON DRAWINGS

The objects, features and advantages of the invention can be further understood through the following description of the preferred embodiments according to the invention with reference to the drawings, wherein:

FIGS. 1a and 1b are illustrative diagrams of QR bar code and MaxiCode bar code;

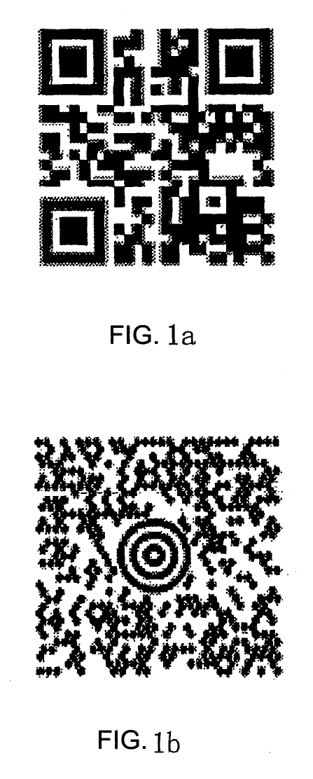

FIGS. 2a and 2b are illustrative diagrams of the reversible ordering; and

FIG. 3 is an illustrative diagram of a two-dimensional bar code having horizontal guiding information for recognition direction.

### BEST MODE FOR CARRYING OUT THE INVENTION

Firstly, a reversible sequence will be described as follows. By means of one-dimensional array, a reversible sequence can be defined as follows:

A={a₁, a₂, . . . , aₙ₋₁, aₙ}

A′={aₙ, aₙ₋₁, . . . , a₂, a₁}

The above arrays have two properties: (1) The arrays A and A′ comprise the same elements; (2) All of the elements in arrays A and A′ are arranged in a reversible order. Such paired arrays having the above properties are called mutually reversible sequences hereinafter.

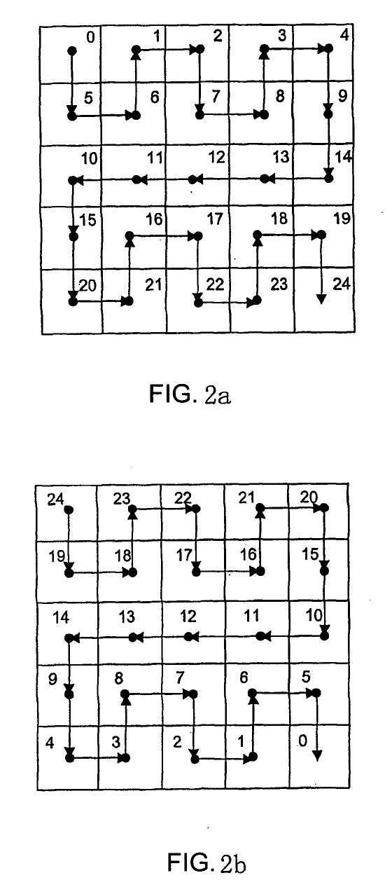

The above one-dimensional arrays can also be used to reflect a distributional rule in a encoding information sequence arranged in two-dimensional bar code matrix, wherein the serial number of a node in the matrix can be represented by the value of an element in the array. Because a node for storing encoding information corresponds to an encoding information cell, the serial number can also be regarded as the serial number of a encoding information cell. For example, in a 5×5 matrix, it is assumed that encoding information on each nodes is read sequentially according to a path or distributional path as shown in FIG. 2a (along a direction indicated by the arrow), thus generating the following sequence B:
B={0, 5, 6, 1, 2, 7, 8, 3, 4, 9, 14, 13, 12, 11, 10, 15, 20, 21, 16, 17, 22, 23, 18, 19, 24}

Rotating the matrix shown in FIG. 2a with 180°, a matrix as shown in FIG. 2b can be obtained. If the encoding information of each nodes is also read sequentially according to the path or the distributional rule as shown in FIG. 2a, then the following sequence B′ can be obtained:
B′={24, 19, 18, 23, 22, 17, 16, 21, 20, 15, 10, 11, 12, 13, 14, 9, 4, 3, 8, 7, 2, 1, 6, 5, 0}

Obviously, the two sequences B and B′ are mutually reversible sequences. It should be noted that a plurality of distributional rules are available for forming reversible sequences, the sequences shown in FIGS. 2a and 2b are only illustrative and shall not be intended to limit the scope of the invention.

The present invention is based on the essential idea describe herein below. The encoding information is disposed according to a distributional rule for forming reversible sequences, thereby encoding information sequences read in both of two recognition directions are mutually reversible sequences. On the other hand, directional symbols are disposed at specific locations having bilateral symmetry in the encoding information sequence for identifying the recognition direction, so that all of the symbols read from those specific locations in two directions are directional symbols, however the symbols in two directions are present in different orders. Therefore, the direction in which the encoding information sequence is disposed during encoding can be determined based on the values of the symbol at the specific location.

Obviously, in the invention, it assumes that a direction in parallel with the recognition direction or the disposing direction, in which the encoding information sequence is disposed, is determined, regardless of being the identical or the opposite to the disposing direction. In practice, this presumption is achievable.

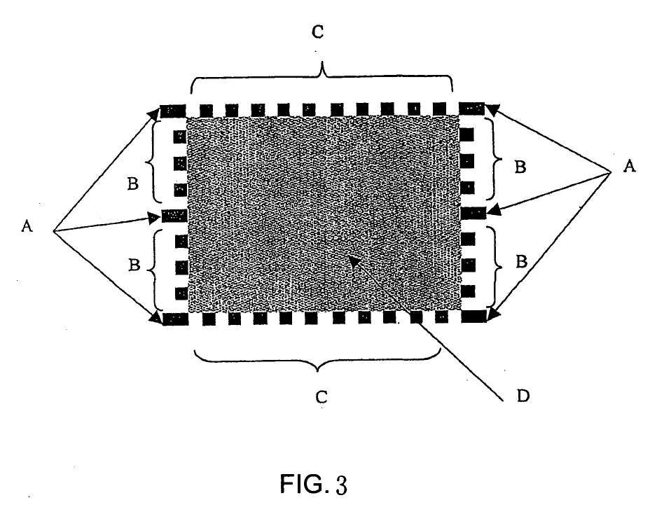

For example, a direction in parallel with or perpendicular to the disposing direction can be marked by setting a tag pattern outside the encoding region. Because of free occupation on the encoding region, it does not affect the information storage density in the two-dimensional bar code system. A typical example is shown in FIG. 3. As shown in FIG. 3, the encoding information sequence of a two-dimensional bar code system (two-dimensional bar code system shown in FIG. 3 will be referred generally to LP code hereinafter) is disposed in a rectangular encoding region D along in a horizontal direction or a perpendicular direction, the horizontal and the perpendicular direction in the two-dimensional bar code can be distinguished by setting anisotropic tag A at the boundary or corner of the encoding region D, so that the disposing direction of the encoding information can be determined. The shape and disposing position of the tag pattern shown in FIG. 3 are only illustrative, it is obvious for the skilled in the art to make various change and modification, thus, the two-dimensional bar code system according to the invention is not limited to the specific structure as shown in FIG. 3. Further, a direction in parallel with or perpendicular to the disposing direction can be determined by means of manual operation. In a word, there are many approaches for determining whether a direction is in parallel with or perpendicular to the disposing direction, thereby satisfying the above presumption.

A preferred embodiment of a two-dimensional bar code system and the recognition method thereof according to the invention will be described below by way of the LP code shown in FIG. 3.

In this embodiment, it assumes that a horizontal direction from left to right shown in FIG. 3 is the disposing direction and decoding direction for encoding information, and an array Info corresponds to a node sequence representing an order in which the encoding information is disposed in encoding region according to a distributional rule:
Info={a₀, a₁, . . . , aₙ₋₁, aₙ}
wherein a₀≈aₙ represent the serial number of the nodes in the matrix of the encoding region. Because an encoding information cell stored in a node corresponds to a node, the above node sequence is equivalent to the encoding information sequence, unless stating explicitly, the encoding information sequence and the node sequence refer to the same sequence in the following description.

As described above, in the two-dimensional bar code system according to the invention, the encoding information is disposed according to a distributional rule for forming reversible sequences, so that the encoding information sequences read from two recognition directions are mutually reversible, in other words, if the LP code in FIG. 3 is rotated with 180° and all of the nodes in the matrix of the encoding region are visited according to the same order or distributional rule, then obtaining the following array Info′:
Info′={aₙ, aₙ₋₁, . . . , a₁, a₀}
i.e., the order of the serial number of the nodes in array Info′ is reversed, therefore, the sequence obtained in such way, representing information about the serial numbers, is reversed. As described above, the reversible sequences can be formed by a variety of distributional rules or orders, and how to select a distributional or order is well known by the skilled in the art, therefore it will not be described herein.

The directional symbols will be described below. In a preferred embodiment, the directional symbols are represented by a directional data array D defined as follow:
D={S11, S10, . . . , S1, S0, STA, R1, R2, R3, R4, STO, S′0, S′1, . . . , S′10, S′11}

The he directional symbols are arranged in the array D in accordance with the following relationship:

A symbol sequence {STO, R₄, R₃, R₂, R₁, STA, S₀, S₁, . . . , S₁₀, S₁₁} acts as one BCH (18, 6) error-correcting code sequence called BCH_{L}, wherein the data symbols consist of 6 data bits {STO, R₄, R₃, R₂, R₁, STA}, and the error-correcting symbols consist of 12 data bits {S₀, S₁, . . . , S₁₀, S₁₁}.

A symbol sequence {STA, R₁, R₂, R₃, R₄, STO, S′₀, S′₁, . . . , S′₁₀, S′₁₁} acts as another BCH (18, 6) error-correcting code sequence called BCH_{R}, wherein data symbols consist of 6 data bits {STA, R₁, R₂, R₃, R₄, STO}, the correction symbols consist of 12 data bits {S′₀, S′₁, . . . , S′₁₀, S′₁₁}.

From above, the error-correcting code sequences BCH_{L} and BCH_{R} share a group of data symbols forming mutually reversible sequences, wherein the data bits STA and STO are the start character and the stop character, respectively, and they are also referred to as the locating control character and function as the directional symbols for identifying the recognition or disposing direction, the other four data bits R1, R2, R3, and R4 indicate information in the two-dimensional bar code, e.g., error-correcting ability, information related to format, version information or the residual of the data block, and the like, and are also referred to as normal information characters. In order to increase locating reliability, the error-correcting ability is provided to the above data symbols of the mutually reversible sequences in the embodiment.

A method for disposing the symbols in the above array D at specific positions having bilateral symmetry in the encoding information sequence will be described below.

Firstly, from its central location, the directional data symbol array D is split into two parts to form two arrays D_{L} and D_{R}:
D_{L}={R₂, R₁, STA, S₀, S₁, . . . , S₁₀, S₁₁}
D_{R}={R₃, R₄, STO, S′₀, S′₁, . . . , S′₁₀, S′₁₁}

Next, from its central location, the array Info is split into two parts to form two arrays Info_{L} and Info_{R}:

If the number of the elements in the array Info is an even, then:
Info_{L}={a_{(n+1)/2}, a_{(n+1)/2-1}, . . . , a₁, a₀}
Info_{R}={a_{(n+1)/2+1}, a_{(n+1)/2+2}, . . . , aₙ₋₁, aₙ}

If the number of the elements in the array Info is an odd, then:
Info_{L}={a_{n/2}, a_{n/2-1}, . . . , a₁, a₀}
Info_{R}={a_{n/2}, a_{n/2+1}, . . . , aₙ₋₁, aₙ}

Finally, the directional symbols of the directional data arrays D_{L} and D_{R} are assigned to or disposed at the specific locations in the encoding information cell arrays Info_{L} and Info_{R} according to the same distributional rule, in other words, these directional symbols are disposed or stored in the specific nodes in the matrix of the encoding region. With the same distributional rule for arranging the directional symbols of D_{L} and D_{R} into the encoding information cell arrays Info_{L} and Info_{R}, and the start point being located in the central location of the encoding information cell array Info, the directional symbols are present at the specific locations having bilateral symmetry in the encoding information cell array Info.

It should be noted that the array Info may be split into in other ways, for example, the following division is available:

If the number of the elements in the array Info is an even, then:
Info_{L}={a₀, a₁, . . . , a_{(n+1)/2-1}, a_{(n+1)/2}}
Info_{R}={aₙ, aₙ₋₁, . . . , a_{(n+1)/2+2}, a_{(n+1)/2+1}}

If the number n of the elements in the array Info is an odd, then:
Info_{L}={a₀, a₁, . . . , a_{n/2-1}, a_{n/2}}
Info_{R}={aₙ, aₙ₋₁, . . . , a_{n/2+1}, a_{n/2}}

Obviously, with the same distributional rules for arranging the directional symbols of the D_{L} and D_{R} into the encoding information cell arrays Info_{L} and Info_{R}, and the start points being located at two ends of the encoding information cell arrays Info, the directional symbols still distribute bilateral-symmetrically in the encoding information cell array Info.

The distributional rule can be expressed by the following distributional function:
i=F(j)
0<=i<n/2
j=0, 1, . . . , 13, 14
i<j
wherein j is the serial number of the location of a directional symbol in the directional data arrays D_{L} or D_{R}, and i is the serial number of its locations in the encoding information cell arrays Info_{L} or Info_{R}. The specific form of the distributional function F greatly depends on the type of the error-correcting code, for example, if the type is of a BCH error-correcting code, then an analog random discrete distribution may be selected.

The process for recognizing the above LP code will be described below.

At step 1, a scanner in a recognition system scans a LP code region having a structure as shown in FIG. 3, which is printed on an article. During scanning, the optical signal derived from each pixel of the LP code image is converted into an analog electrical signal by the scanner, and a digital image of the LP code is obtained after completing analog to digital conversion for all of the analog electrical signals.

At step 2, a digital image processing unit in the recognition system determines the range of the LP code region and one possible direction in which the LP code can be identified and read (i.e., one direction being identical or opposite to one in which an encoding information sequence is disposed) based on specific tag pattern in the digital image. In this possible direction, available information from the LP codes are extracted sequentially from the nodes in the encoding region based on the same distributional rule as that used for disposing the encoding information sequence, so as to obtain an information unit array Info″:

If the number of the nodes is an even, then:
Info″={a′₀, a′₁, . . . , a′_{(n+1)/2-1}, a′_{(n+1)/2}, a′_{(n+1)/2+1}, . . . , a′ₙ₋₁, a′ₙ}

If the number of the nodes is an odd, then:
Info″={a′₀, a′₁, . . . , a′_{n/2-1}, a′_{n/2}, a′_{n/2+1}, . . . , a′ₙ₋₁, a′ₙ}

Obviously, in case the recognition direction and the direction for disposing the encoding information sequence coincide, the arrays Info″ and Info shall be identical (assuming no error code occurs) or partly identical (assuming any error code occurs); in case the recognition direction and the direction for disposing the encoding information sequence are opposite, the arrays Info″ and Info′ shall be identical (assuming no error code occurs) or partly identical (assuming any error code occurs).

At step 3, then the array Info″ is split into two parts from the central location to form two groups of arrays Info′_{L} and Info′_{R}:

If the number of the elements in the array Info″ is an even, then:
Info′_{L}={a′_{(n+1)/2}, a′_{(n+1)/2-1}, . . . , a′₁, a′₀}
Info′_{R}={a′_{(n+1)/2+1}, a′_{(n+1)/2+2}, . . . , a′ₙ₋₁, a′ₙ}

If the number of the elements in the array Info″ is an odd, then:
Info′_{L}={a′_{n/2}, a′_{n/2-1}, . . . , a′₁, a′₀}
Info′_{R}={a′_{n/2}, a′_{n/2+1}, . . . , a′ₙ₋₁, a′ₙ}

At step 4, the directional data arrays D′_{L} and D′_{R} are derived from the specific locations in the encoding information cell arrays Info′_{L} and Info′_{R} according to the same distributional rule as that used for disposing the encoding information sequences:
D′_{L}={R′₂, R′₁, STA′, T₀, T₁, . . . , T₁₀, T₁₁}
D′_{R}={R₃, R′₄,STO′, T′₀, T′₁, . . . , T′₁₀, T′₁₁}

In step 5, sequences BCH (18, 6) error-correcting codes BCH′_{L} and BCH′_{R} are restored according to the directional data array defined as above:
BCH′_{L}={STO′, R′₄, R′₃, R′₂, R′₁, STA′, T₀, T₁, . . . , T₁₀, T₁₁}
BCH′_{R}={STA′, R′₁, R′₂, R′₃, R′₄, STO′, T′₀, T′₁, . . . , T′₁₀, T′₁₁}

If the recognition direction and the direction for disposing the encoding information sequence coincide, then D′_{L} corresponds to D_{L}, D′_{R} corresponds to D_{R}, BCH′_{L} corresponds to BCH_{L}, BCH′_{R} corresponds to BCH_{R}, i.e., the directional symbols STO′, R′₄, R′₃, R′₂, R′₁, STA′ correspond to the directional symbols STO, R₄, R₃, R₂, R₁, STA, respectively, T₀, T₁, . . . , T₁₀, T₁₁ correspond to S₀, S₁, . . . , S₁₀, S₁₁, respectively, and T′₀, T′₁, . . . , T′₁₀, T′₁₁ correspond to S′₀, S′₁, . . . , S′₁₀, S′₁₁, respectively. On the contrary, if the recognition direction and the direction for disposing the encoding information sequence are opposite, then D′_{L} corresponds to D_{R}, D′_{R} corresponds to D_{L}, BCH′_{L} corresponds to BCH_{R}, BCH′_{R} corresponds to BCH_{L}, i.e., the directional symbols STO′, R′₄, R′₃, R′₂, R′₁, STA′ correspond to the directional symbols STA, R₁, R₂, R₃, R₄, STO, respectively, T₀, T₁, . . . , T₁₀, T₁₁ correspond to S′₀, S′₁, . . . , S′₁₀, S′₁₁, respectively, and T′₀, T′₁, . . . , T′₁₀, T′₁₁ correspond to S₀, S′₁, . . . , S₁₀, S₁₁, respectively.

In step 6, the error-correcting symbols T₀, T₁, . . . , T₁₀, T₁₁ and T′₀, T′₁, . . . , T′₁₀, T′₁₁ from decoding are used to check and error-correct the data symbols in BCH′_{L} and BCH_{L}, respectively, resulting in correct values of these symbols.

At step 7, the disposing direction or decoding direction of the encoding information sequence is determined based on the values of the data symbols STA′ and STO′ in the error-correcting codes BCH′_{L} and BCH′_{R}. Specifically, if the STA′ is identical with the STA and/or the STO′ is identical with the STO, then it can conclude that the current recognition direction coincides with the disposing direction or the decoding direction of the encoding information sequence; in contrast, if the STA′ is identical with the STO and/or the STO′ is identical with the STA, then it can conclude that the current recognition direction and the disposing direction or the decoding direction of the encoding information sequence are opposite.

Then, at step 8, the encoding information sequence is decoded for restoring information stored by the LP code in the decoding direction determined as above.

What is claimed is:

1. A two-dimensional bar code system recognizable in bidirection, including an encoding region consisting of nodes arranged in a form of matrix, an encoding information sequence is disposed sequentially on said nodes of said matrix in one direction and in a reversible order, and comprises directional symbols, wherein said directional symbols are arranged at specific locations having bilateral symmetry in said encoding information sequence, said direction in which said encoding information sequence is disposed on said nodes of said matrix is identified by a combination of said specific locations and values of said directional symbols.

2. The system as claimed in claim 1, wherein said directional symbols comprise data symbols and error-correcting symbols.

3. The system as claimed in claim 2, wherein said directional symbols consist of symbols S₁₁, S₁₀, . . . , S₁, S₀, STA, R₁, R₂, R₃, R₄, STO, S′₀, S′₁, . . . , S′₁₀, S′₁₁, which comply with a relationship as follow:
a symbol sequence {STO, R₄, R₃, R₂, R₁, STA, S₀, S₁, . . . , S₁₀, S₁₁} acts as one BCH (18, 6) error-correcting code sequence, a symbol sequence {STA, R₁, R₂, R₃, R₄, STO, S′₀, S′₁, . . . , S′₁₀, S′₁₁} acts as another BCH (18, 6) error-correcting code sequence, symbols STA, STO and R₁≈R₄ are said data symbols, symbols STA, STO function as locating control characters indicating said direction, R₁≈R₄ functions as normal information characters, S₀≈S₁₁ and S′₀≈S′₁₁ are said error-correcting symbols belonging to said error-correcting code sequences.

4. The system as claimed in claim 3, wherein said directional symbols are arranged at said specific locations having bilateral symmetry in such a way that:
said directional symbols R₂, R₁, STA, S₀, S₁, . . . , S₁₀, S₁₁ correspond to locations within left half part of said encoding information sequence according to a distributional rule, and said directional symbols R₃, R₄, STO, S′₀, S′₁, . . . , S′₁₀, S′₁₁ correspond to locations within right half part of said encoding information sequence according to said distributional rule.

5. The system as claimed in claim 4, wherein said distributional rule complies with an analog random discrete distribution.

6. A method for recognizing a two-dimensional bar code system as claimed in claim 1, comprising the steps of:
(1) reading encoding information at said nodes within said matrix in one recognition direction and in said reversible order to obtain said encoding information sequence;
(2) extracting said directional symbols from said specific locations in obtained encoding information sequence; and
(3) determining said direction in which said encoding information sequence is disposed on said node of said matrix based on said combination of said specific locations and values of said directional symbols.

7. The method as claimed in claim 6, wherein said directional symbols comprise data symbols and error-correcting symbols.
